(19) United States
(12) Patent Application Publication
(10) Pub. No.: US 2022/0014324 A1
(43) Pub. Date: Jan. 13, 2022

(54) REFERENCE SIGNAL TRANSMITTING AND RECEIVING METHOD, BASE STATION, TERMINAL, STORAGE MEDIUM, AND SYSTEM

(71) Applicant: SPREADTRUM COMMUNICATIONS (SHANGHAI) CO., LTD., Shanghai (CN)

(72) Inventors: Xingya SHEN, Shanghai (CN); Hualei WANG, Shanghai (CN)

(21) Appl. No.: 16/321,654

(22) PCT Filed: Jan. 21, 2019
(86) PCT No.: PCT/CN2019/072480

§ 371 Date: Sep. 17, 2021

(30) Foreign Application Priority Data
Feb. 13, 2018 (CN) 201810153172.0

(51) Int. Cl. H04L 5/00; H04W 72/04; H04W 56/00

(52) U.S. Cl. CPC H04L 5/0048; H04L 5/0053; H04W 56/001; H04W 72/044

(57) ABSTRACT

There is provided a method for transmitting a reference signal. The method for transmitting the reference signal includes: determining locations in time and frequency domains of a DRS, the DRS comprising at least one of a PSS, an SSS, a PBCH, a DMRS for PBCH, a CSI-RS for TRS, a CSI-RS for beam management, and a CSI-RS for acquiring channel state information; and transmitting the DRS at the determined locations in time and frequency domains of the DRS.

### CROSS-REFERENCE

This application is a U.S. national stage application of the PCT International Application No. PCT/CN2019/072480 filed on Jan. 21, 2019, which claims the priority of foreign priority of Chinese patent application No. 201810153172.0 filed on Feb. 13, 2018, the contents all of which are incorporated herein by reference.

### TECHNICAL FIELD

Embodiment of the present disclosure relates to the technical field of communication system, in particular, to a method for transmitting a reference signal, a method for receiving the reference signal, a base station, a terminal, a storage medium, and a system.

### BACKGROUND

In a New Radio (NR) system, when a User Equipment (UE) communicates with a base station (gNB), it needs to be synchronized with the base station in time and frequency domains. Synchronization signal and tracking signal are mainly required for the UE to access a network. The synchronization signal is used for the synchronization of the UE and the network in the time and frequency domains. The tracking signal helps the UE to synchronize with the network precisely for a long period in the time and frequency domains.

In a Long Term Evolution (LTE) system, Discover Reference Signal (DRS) defined in 3GPP is used for the purposes of synchronization of UE and the base station, channel measurement, and the likes.

### SUMMARY

In the embodiments of the present disclosure there is provided a method for transmitting the reference signal. The method comprises determining locations in time and frequency domains of a Discover Reference Signal (DRS); the DRS comprises at least one of a Primary Synchronization Signal (PSS), a Secondary Synchronization Signal (SSS), a Physical Broadcast Channel (PBCH), a Demodulation Reference Signal (DMRS) for PBCH, a Channel State Information Reference Signal (CSI-RS) for Tracking Reference Signal (TRS), a CSI-RS for beam management, and a CSI-RS for acquiring channel state information. The method further comprises transmitting the DRS at the determined locations in time and frequency domains of the DRS.

In the embodiments of the present disclosure there is provided a method for receiving the reference signal. The method comprises: determining locations in time and frequency domains of a DRS; the DRS comprises at least one of a PSS, an SSS, a PBCH, a DMRS for PBCH, a CSI-RS for TRS, a CSI-RS for beam management, and a CSI-RS for acquiring channel state information. The method further comprises receiving the DRS at the determined locations in time and frequency domains of the DRS.

In embodiments of the present disclosure there is provided a base station system. The base station system comprises a memory and a processor; the memory stores computer instructions executable on the processor to: determine locations in time and frequency domains of a Discover Reference Signal (DRS), the DRS comprising at least one of a Primary Synchronization Signal (PSS), a Secondary Synchronization Signal (SSS), a Physical Broadcast Channel (PBCH), a Demodulation Reference Signal (DMRS) for PBCH, a Channel State Information Reference Signal (CSI-RS) for Tracking Reference Signal (TRS), a CSI-RS for beam management, and a CSI-RS for acquiring channel state information; and transmit the DRS at the determined locations in time and frequency domains of the DRS.

In embodiments of the present disclosure there is provided a terminal system. The terminal system comprises a memory and a processor; the memory stores computer instructions executable on the processor to determine locations in time and frequency domains of a Discovery Reference Signal (DRS), the DRS comprising at least one of a Primary Synchronization Signal (PSS), a Secondary Synchronization Signal (SSS), a Physical Broadcast Channel (PBCH), a Demodulation Reference Signal (DMRS) for PBCH, a Channel State Information Reference Signal (CSI-RS) for Tracking Reference Signal (TRS), a CSI-RS for beam management, and a CSI-RS for acquiring channel state information; and receive the DRS at the determined locations in time and frequency domains of the DRS.

### BRIEF DESCRIPTION OF THE DRAWINGS

FIG. 1 is a flowchart of the method for transmitting reference signal according to an embodiment of the present disclosure.

FIG. 2 is a schematic diagram of the distribution in time and frequency domains of the SSB in a time slot.

FIG. 3 is a schematic diagram of the distribution in time domain of the SSB in an SS burst.

FIG. 4 is a schematic diagram of a distribution of reference signal in an SS burst.

FIG. 5 is a schematic diagram of other distribution of reference signal in an SS burst.

FIG. 6 is a flowchart of the method for receiving reference signal according to an embodiment of the present disclosure.

FIG. 7 is a structural diagram of the base station according to an embodiment of the present disclosure.

FIG. 8 is a structural diagram of the terminal according to an embodiment of the present disclosure.

### DETAILED DESCRIPTION

One skilled in the art understands that, as mentioned in the background sections, in order to facilitate the access by a user to the network, and to acquire radio frame information, the reference signal (i.e., Discovery Reference Signal, DRS) needs to be configured as periodic signal. However, in unlicensed spectrums, all users compete for spectrum resource fairly. Take the Listen-Before-Talk (LBT) as an example, in the LBT, the user equipment (UE) occupies spectrum resources when the spectrum is idle. In order to ensure a continuous transmission of the reference signal, a tracking signal needs to be transmitted to occupy the spectrum.

To support the unlicensed spectrum, 3GPP introduces an LBT mechanism to ensure a fair coexistence of devices using different communications technologies. LTE-LAA (Licensed Assisted Access) includes DRS (also referred to as reference signal) for synchronization and channel measurement by the UE.

The research of NR LAA will further develop a new LBT technology based on NR such that NR LAA will become a good neighbor for other technologies in the unlicensed spectrum.

However, in current NR systems, there is no reference signal configured for synchronization and access of the unlicensed spectrum. This hinders channel access by the UE to the NR network.

Embodiments of the present disclosure solve the technical problem of how to transmit the DRS to the UE so that the UE can perform synchronization and channel access based on the DRS.

To solve the above technical problem, the present disclosure provides a method for transmitting the reference signal, comprising: determining locations in time and frequency domains of a DRS, the DRS comprising at least one of a PSS, an SSS, a PBCH, a DMRS for PBCH, a CSI-RS for TRS, a CSI-RS for beam management, and a CSI-RS for acquiring channel state information; and transmitting the DRS at the determined locations in time and frequency domains of the DRS. One skilled in the art may understands that, the technical solution of the present disclosure is capable of transmitting reference signal (DRS) in an NR system to ensure that the UE of the NR system (in particular in the unlicensed spectrum) can perform synchronization and channel access based on the DRS, so as to access the NR network successfully.

Furthermore, the SSB includes the PSS, the SSS, the PBCH and the DMRS for PBCH of adjacent symbols, and the SSB and the CSI-RS meet a relationship that, in two adjacent time slots corresponding to the SSB, there is at least one CSI-RS resource, for the channel estimation, the beam management, the acquisition of the TRS and the likes by the UE, so as to maintain (precise) synchronization with the base station in time and frequency domains.

To make the afore-mentioned objects, features and advantages of the present disclosure apparent and easy to understand, embodiments of the present disclosure are described below in detail with reference to the drawings.

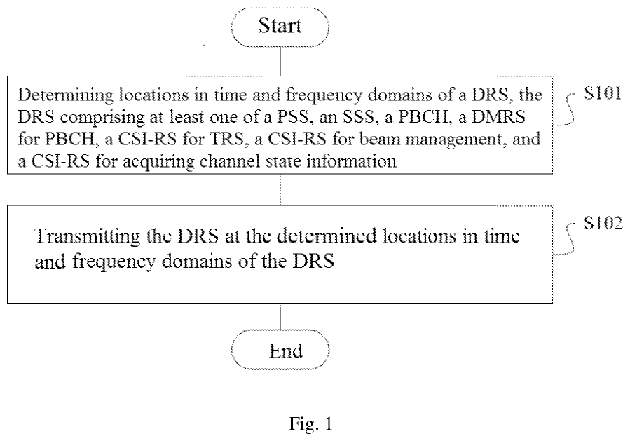

FIG. 1 is a flowchart of the method for transmitting reference signal according to an embodiment of the present disclosure. The reference signal refers to the Discover Reference Signal (DRS) used for the synchronization with the network, the channel measurement and the likes by the user equipment (UE). The embodiment of the present disclosure may be applied on the network side, for example, executed by a base station on the network side. The network side may refer to the NR network side, and the base station may refer to a 5G base station (gNB).

The embodiment is preferably adapted for a scenario where the subcarrier spacing (SCS) is 15 kHz (or 30 kHz).

Specifically, the method for transmitting reference signal according to the embodiment may include the following steps.

In S101, the locations in time and frequency domains of the DRS are determined, the DRS comprising at least one of the Primary Synchronization Signal (PSS), the Secondary Synchronization Signal (SSS), the Physical Broadcast Channel (PBCH), the Demodulation Reference Signal (DMRS) for PBCH, the Channel State Information Reference Signal (CSI-RS) for Tracking Reference Signal (TRS), the CSI-RS for beam management, and the CSI-RS for acquiring Channel State Information (CSI).

In a S102, the DRS is transmitted at the determined locations in time and frequency domains of the DRS.

More specifically, the synchronization signal in NR system is called Synchronization Signal Block (SSB) and is used for synchronization of the UE with the network in time and frequency domains.

In a non-limiting embodiment, the SSB may include PSS, SSS, and PBCH in adjacent symbols. The SSB may also include the DMRS for PBCH (also known as the DMRS of PBCH).

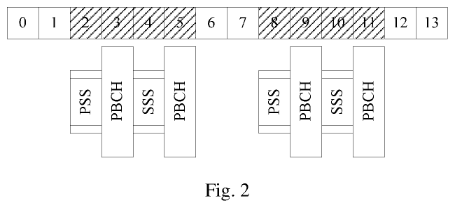

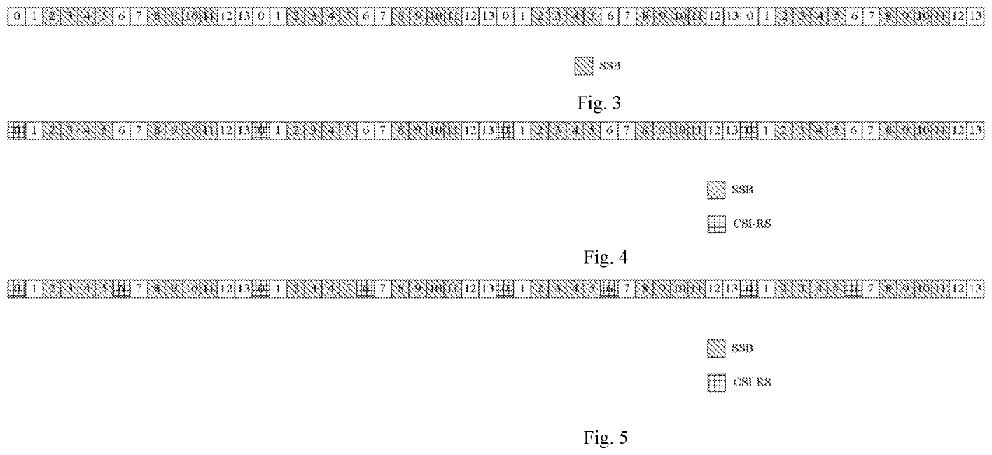

In a scenario where the subcarrier spacing (SCS) is 15 kHz, a pattern of the SSB in one time slot may be as shown in FIG. 2. FIG. 3 shows the distribution in time domain of the SSB in an SS burst (Synchronization Signal burst). Taking one time slot as an example, in a slot including 14 symbols (the zeroth symbol to the thirteenth symbol), the PSS may be located in the second and eighth symbols in each time slot; the SSS may be located in the fourth and the tenth symbols in each time slot; and the PBCH and the DMRS for PBCH may be located in the third, fifth, ninth, and eleventh symbols in each time slot in a manner of frequency division multiplexing. It should be noted that, the zeroth symbol refers the symbol with an index of 0; and the thirteenth symbol refers to the symbol with an index of 13.

Further, in each time slot corresponding to the SSB, there is at least one CSI-RS resource. The CSI-RS may serve as a tracking signal to facilitate the UE to synchronize with the network precisely for a long period in the time and frequency domain.

In a non-limiting embodiment, the CSI-RS for TRS may be located in at least one of the zeroth and the sixth symbols in each time slot of the SS burst.

For example, as shown in FIG. 4, the CSI-RS for TRS may be located in the zeroth symbol in each time slot to occupy a bit (occupy the spectrum), so as to ensure a continuous transmission of the DRS. Specifically, the spectrum resource of a time slot can be occupied from the zeroth symbol, i.e. the starting symbol, of that time slot, and can further be occupied continuously by the CSI-RS for tracking (i.e. the CSI-RS for TRS) in the sixth symbol, enabling a continuous transmission of the reference signal when the channel condition changes, thereby further realizing the synchronization between the transmitting end and the receiving end (like the base station and the UE) in time and frequency domains.

In a further embodiment, as shown in FIG. 5, the CSI-RS for TRS may be located in the zeroth and the sixth symbols of each time slot.

In a further embodiment, the CSI-RS for TRS may be located in the sixth symbol of each time slot.

In a variant, the CSI-RS for TRS may be located in at least one of the zeroth, the first, the sixth, the seventh, the twelfths and the thirteenth symbols in each time slot, i.e. in at least one of the symbols that have not been occupied by the SSB in each time slot corresponding to the SSB, wherein the earlier the symbol occupied by the CSI-RS for TRS is ordered, the better the performance will be. For example, the performance will be the best when the CSI-RS for TRS is located in the zeroth symbol of each slot.

In a non-limiting embodiment, the CSI-RS for beam management or the CSI-RS for acquiring CSI may be located in at least one symbol in each time slot of the SS burst.

In an application, as shown in FIG. 5, for one time slot, the SSB is located in the second, the third, the fourth, the fifth, the eighth, the ninth, the tenth, and the eleventh symbols in that time slot, wherein the specific distributions of the PSS, the SSS, the PBCH, and the DMRS for PBCH are shown in FIG. 2 and will not be repeated.

Further, in this time slot, the CSI-RS for TRS is located in the zeroth symbol (or located in the zeroth and the sixth symbols).

Further, in this time slot, the CSI-RS for beam management or the CSI-RS for acquiring CSI is located in at least one of the seventh, the twelfth and the thirteenth symbols (i.e., located in at least one of the rest un-occupied symbols of the time slot). For example, the CSI-RS for beam management and the CSI-RS for acquiring channel state information may be respectively located in at least one of the rest un-occupied symbols.

At this time, the time slot is occupied to transmit the reference signal.

In a preferable embodiment, the locations in the time slot for the SSB, the CSI-RS for TRS, the CSI-RS for beam management, and the CSI-RS for signal state indication may be predetermined according to a protocol.

Or, the locations of in time domain for the SSB and the likes may be indicated by the base station via high-layer signaling.

In a non-limiting embodiment, the CSI-RS may have a frequency domain density of 3 and a location in frequency domain starting from a subcarrier 0 or a subcarrier N, wherein N is a natural number, and 0≤N≤11.

For example, the location in frequency domain of the CSI-RS may be predetermined by a protocol as starting from the subcarrier 0.

Or, the value of N may be indicated by the high-layer signaling to determine the starting position of the CSI-RS in frequency domain.

In a variant, the CSI-RS may have a frequency domain density of 1 and a location in frequency domain starting from a subcarrier 0 or a subcarrier N, wherein N is a natural number, and 0≤N≤11.

In a further variant, the CSI-RS may have a frequency domain density of ½ and a location in frequency domain starting from a subcarrier 0 or a subcarrier N, wherein N is a natural number, and 0≤N≤23.

Further, the method for transmitting reference signal according to the embodiment of the present disclosure further comprises indicating a location in time domain of the SSB by high-layer signaling; and indicating a location in frequency domain of the SSB by the high-layer signaling; wherein the location in frequency domain may include a center frequency corresponding to the SSB.

Preferably, the center frequency is a Global Synchronization Channel Number (GSCN).

Preferably, the content indicated by the high-layer signaling may include offset information of the center frequency corresponding to the SSB from a common Physical Resource Block (PRB) index 0.

Preferably, the high-layer signaling may be carried in a Radio Resource Control (RRC) signaling, in a Remain Minimum System Information (RMSI), or in Other System Information (OSI).

According to the foregoing, by the technical solution of the present disclosure, the reference signal (DRS) can be transmitted in an NR system to ensure that the UE of NR system (in particular in an unlicensed spectrum) can perform synchronization and channel access based on the DRS, so as to access the NR network successfully.

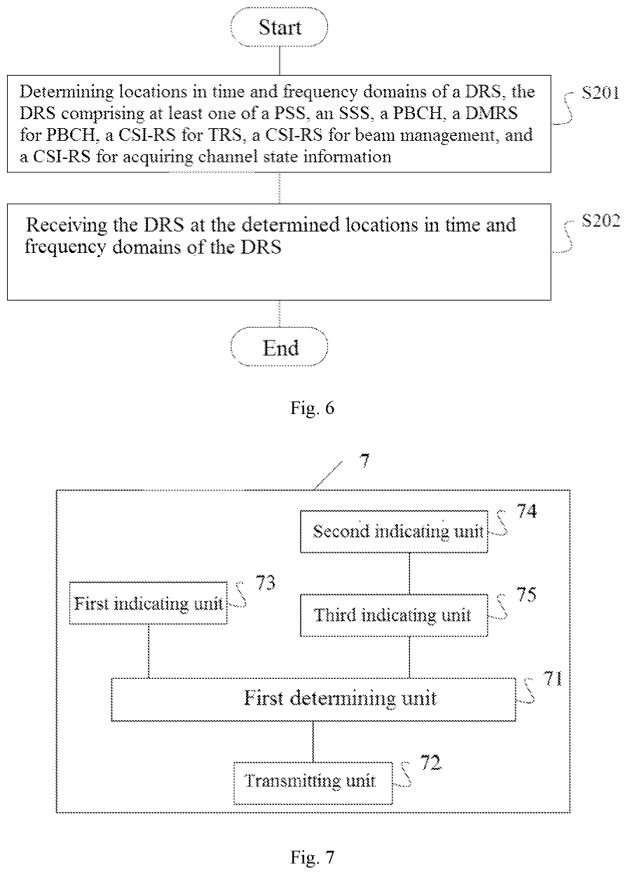

FIG. 6 is a flowchart of the method for receiving reference signal according to an embodiment of the present disclosure. The embodiment of the present disclosure may be used by a user equipment, for example, may be executed by a UE.

Specifically, the method for receiving reference signal according to the embodiment may include the following steps.

In S201, the locations in time and frequency domains of the DRS are determined, the DRS comprising at least one of a PSS, an SSS, a PBCH, a DMRS for PBCH, a CSI-RS for TRS, a CSI-RS for beam management, and a CSI-RS for acquiring channel state information.

In S202, the DRS is received at the determined locations in time and frequency domains of the DRS.

More specifically, the terms used in the embodiment are interpreted by taking reference to the description of the foregoing embodiment as shown in FIGS. 1 to 5 and will not be repeated herein.

Further, the SSB may include the PSS, the SSS, the PBCH and the DMRS for PBCH of adjacent symbols, and the SSB and the CSI-RS meet a relationship that, in each time slot corresponding to the SSB, there is at least one CSI-RS resource.

Further, the CSI-RS for TRS can be located in at least one of a zeroth symbol and a sixth symbol in a first time slot of an SS burst.

Further, the CSI-RS for beam management or the CSI-RS for acquiring channel state information can be located in at least one symbol in each time slot of an SS burst.

According to the foregoing, the technical solution of the present disclosure ensures that the UE of NR system successively receives the DRS so as to be synchronized or even precisely synchronized with the NR network in the time and frequency domains, so that the UE can access the NR network successfully.

FIG. 7 is a structural diagram of the base station according to an embodiment of the present disclosure. One skilled in the art may understand that the base station 7 of the embodiment is applicable to implement the technical solution of the embodiments shown in FIGS. 1 to 5.

Specifically, in the embodiment, the base station 7 may comprise: a first determining unit 71 adapted to determine locations in time and frequency domains of a DRS, the DRS comprising at least one of a PSS, an SSS, a PBCH, a DMRS for PBCH, a CSI-RS for TRS, a CSI-RS for beam management, and a CSI-RS for acquiring channel state information; and a transmitting unit 72 adapted to transmit the DRS at the determined locations in time and frequency domains of the DRS.

Further, the SSB may include the PSS, the SSS, the PBCH and the DMRS for PBCH of adjacent symbols, and the SSB and the CSI-RS meet a relationship that, in each time slot corresponding to the SSB, there is at least one CSI-RS resource.

Further, the CSI-RS for TRS is located in at least one of a zeroth symbol and a sixth symbol in a first time slot of an SS burst.

Further, the CSI-RS for beam management or the CSI-RS for acquiring CSI may be located in at least one symbol in each time slot of an SS burst.

In a non-limiting embodiment, the CSI-RS may have a frequency domain density of 3 and a location in frequency domain starting from a subcarrier 0 or a subcarrier N, wherein N is a natural number, and 0≤N≤11.

In a variant, the CSI-RS may have a frequency domain density of 1 and a location in frequency domain starting from a subcarrier 0 or a subcarrier N, wherein N is a natural number, and 0≤N≤11.

In a further variant, the CSI-RS may have a frequency domain density of ½ and a location in frequency domain starting from a subcarrier 0 or a subcarrier N, wherein N is a natural number, and 0≤N≤23.

Further, the base station 7 may further comprise a first indicating unit 73 adapted to indicate a value of N by the high-layer signaling.

Further, the base station 7 may further comprises a second indicating unit 74 adapted to indicate a location in time domain of the SSB by the high-layer signaling; and a third indicating unit 75 adapted to indicate a location in frequency domain of the SSB by the high-layer signaling.

Preferably, the location in frequency domain includes a center frequency corresponding to the SSB.

Preferably, the center frequency is a Global Synchronization Channel Number (GSCN).

Preferably, the content indicated by the high-layer signaling may include offset information of the center frequency corresponding to the SSB from a common PRB index 0.

The descriptions with reference to FIGS. 1 to 5 can be referred to for the working principles, implementations, and advantages of the base station 7, which will not be repeated herein.

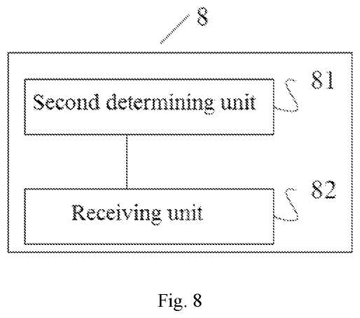

FIG. 8 is a structural diagram of the terminal according to an embodiment of the present disclosure. One skilled in the art may understand that the terminal 8 according to the embodiment of the present disclosure is applicable to execute the method according to the embodiment shown in FIG. 6. The terminal may be a UE.

Specifically, in the embodiment, the terminal 8 may comprise a second determining unit 81 adapted to determine locations in time and frequency domains of a DRS, the DRS comprising at least one of a PSS, an SSS, a PBCH, a DMRS for PBCH, a CSI-RS for TRS, a CSI-RS for beam management, and a CSI-RS for acquiring channel state information; and a receiving unit 82 adapted to receive the DRS at the determined locations in time and frequency domains of the DRS.

Further, the SSB may include the PSS, the SSS, the PBCH and the DMRS for PBCH of adjacent symbols, and the SSB and the CSI-RS meet a relationship that, in each time slot corresponding to the SSB, there is at least one CSI-RS resource.

Further, the CSI-RS for TRS can be located in at least one of a zeroth symbol and a sixth symbol in a first time slot of an SS burst.

Further, the CSI-RS for beam management or the CSI-RS for acquiring channel state information can be located in at least one symbol in each time slot of an SS burst.

The descriptions with reference to FIG. 6 can be referred to for the working principles, implementations, and advantages of the terminal 8, which will not be repeated herein.

The embodiment of the present disclosure provides a computer readable storage medium (referred as storage medium). The computer readable storage medium is a non-volatile memory or a non-transitory memory, storing computer instructions, wherein when executed the computer instructions perform steps corresponding to any of the afore-described methods, which will not be repeated herein.

The embodiment of the present disclosure provides a system comprising a memory and a processor. The memory stores computer instructions executable on the processor, and the processor is configured, when the computer instructions are executed, to perform the steps corresponding to any of the afore-described methods, which will not be repeated herein. Preferably, the system may be an NR system and may include the base station and the terminal.

One skilled in the art understands that all or a part of the steps of the methods according to the afore-described embodiments may be implemented by an associated hardware under instructions of a program. The program may be stored in a computer readable storage medium including: a ROM, a RAM, a magnetic disk, an optical disk, etc.

Although the embodiments of the present disclosure have been described above, the present disclosure is not limited thereto. A number of variations and modifications may occur to one skilled in the art without departing from the scopes and spirits of the present disclosure. Therefore, it is intended that the scope of protection of the present disclosure is defined by the claims.

1. A method for transmitting a reference signal, comprising:
determining locations in time and frequency domains of a Discover Reference Signal (DRS), the DRS comprising at least one of a Primary Synchronization Signal (PSS), a Secondary Synchronization Signal (SSS), a Physical Broadcast Channel (PBCH), a Demodulation Reference Signal (DMRS) for PBCH, a Channel State Information Reference Signal (CSI-RS) for Tracking Reference Signal (TRS), a CSI-RS for beam management, and a CSI-RS for acquiring channel state information; and
transmitting the DRS at the determined locations in time and frequency domains of the DRS.

2. The method according to claim 1, wherein a Synchronization Signal Block (SSB) includes the PSS, the SSS, the PBCH and the DMRS for PBCH of adjacent symbols, and the SSB and the CSI-RS meet a relationship that, in each time slot corresponding to the SSB, there is at least one CSI-RS resource.

3. The method according to claim 2, wherein the CSI-RS for TRS is located in at least one of a zeroth symbol and a sixth symbol in each time slot of a Synchronization Signal burst (SS burst).

4. The method according to claim 2, wherein the CSI-RS for beam management or the CSI-RS for acquiring channel state information is located in at least one symbol in each time slot of a Synchronization Signal burst (SS burst).

5. The method according to claim 2, wherein the CSI-RS has a frequency domain density of 3 and a location in frequency domain starting from a subcarrier 0 or a subcarrier N, wherein N is a natural number, and 0≤N≤11.

6. The method according to claim 2, wherein the CSI-RS has a frequency domain density of 1 and a location in frequency domain starting from a subcarrier 0 or a subcarrier N, wherein N is a natural number, and 0≤N≤11.

7. The method according to claim 2, wherein the CSI-RS has a frequency domain density of ½ and a location in frequency domain starting from a subcarrier 0 or a subcarrier N, wherein N is a natural number, and 0≤N≤23.

8. The method according to claim 5, further comprising:
indicating a value of N by high-layer signaling.

9. The method according to claim 2, further comprising:
indicating a location in time domain of the SSB by high-layer signaling; and
indicating a location in frequency domain of the SSB by the high-layer signaling.

10. The method according to claim 9, wherein the location in frequency domain includes a center frequency corresponding to the SSB.

11. The method according to claim 10, wherein the high-layer signaling includes offset information of the center frequency corresponding to the SSB from a common Physical Resource Block (PRB) index 0.

12-15. (canceled)

16. A base station, comprising a memory and a processor, the memory storing computer instructions causing the processor to:
a first determining unit adapted to determine locations in time and frequency domains of a Discovery Reference Signal (DRS), the DRS comprising at least one of a Primary Synchronization Signal (PSS), a Secondary Synchronization Signal (SSS), a Physical Broadcast Channel (PBCH), a Demodulation Reference Signal (DMRS) for PBCH, a Channel State Information Reference Signal (CSI-RS) for Tracking Reference Signal (TRS), a CSI-RS for beam management, and a CSI-RS for acquiring channel state information; and
a transmitting unit adapted to transmit the DRS at the determined locations in time and frequency domains of the DRS.

17. The base station according to claim 16, wherein a Synchronization Signal Block (SSB) includes the PSS, the SSS, the PBCH and the DMRS for PBCH of adjacent symbols, and the SSB and the CSI-RS meet a relationship that, in each time slot corresponding to the SSB, there is at least one CSI-RS resource.

18. The base station according to claim 17, wherein the CSI-RS for TRS is located in at least one of a zeroth symbol and a sixth symbol in a first time slot of a Synchronization Signal burst (SS burst).

19. The base station according to claim 17, wherein the CSI-RS for beam management or the CSI-RS for acquiring channel state information is located in at least one symbol in each time slot of a Synchronization Signal burst (SS burst).

20. The base station according to claim 17, wherein the CSI-RS has a frequency domain density of 3 and a location in frequency domain starting from a subcarrier 0 or a subcarrier N, wherein N is a natural number, and 0≤N≤11.

21. The base station according to claim 17, wherein the CSI-RS has a frequency domain density of 1 and a location in frequency domain starting from a subcarrier 0 or a subcarrier N, wherein N is a natural number, and 0≤N≤11.

22. The base station according to claim 17, wherein the CSI-RS has a frequency domain density of ½ and a location in frequency domain starting from a subcarrier 0 or a subcarrier N, wherein N is a natural number, and 0≤N≤23.

23. The base station according to claim 20, wherein the computer instructions cause the processor to:
indicate a value of N by high-layer signaling.

24-30. (canceled)

31. A non-transitory storage medium storing computer instructions, wherein the computer instructions cause a processor to:
determine locations in time and frequency domains of a Discover Reference Signal (DRS), the DRS comprising at least one of a Primary Synchronization Signal (PSS), a Secondary Synchronization Signal (SSS), a Physical Broadcast Channel (PBCH), a Demodulation Reference Signal (DMRS) for PBCH, a Channel State Information Reference Signal (CSI-RS) for Tracking Reference Signal (TRS), a CSI-RS for beam management, and a CSI-RS for acquiring channel state information; and
transmit the DRS at the determined locations in time and frequency domains of the DRS.

32. (canceled)
